(19) United States
(12) Patent Application Publication
(10) Pub. No.: US 2021/0398233 A1
(43) Pub. Date: Dec. 23, 2021

(54) Systems and Methods for Licensing, Distribution, and Sales Automation

(71) Applicant: Charles E. Shoffner, Greenville, SC (US)

(72) Inventor: Charles E. Shoffner, Greenville, SC (US)

(21) Appl. No.: 17/368,327

(22) Filed: Jul. 6, 2021

Related U.S. Application Data
(63) Continuation of application No. 16/104,418, filed on Aug. 17, 2018, now abandoned.
(60) Provisional application No. 62/547,326, filed on Aug. 18, 2017.

(51) Int. Cl. G06Q 50/18; G06Q 50/16

(52) U.S. Cl. CPC G06Q 50/18; G06Q 2220/18; G06Q 50/16

(57) ABSTRACT

A system and method for automating licensing, distribution, and sales for goods and/or services. A method includes receiving, at a management platform, a lead identifier, determining, at the management platform, whether one or more lead requirements has been satisfied by the lead identifier, sending, by the management platform, an electronic approval request for the lead identifier, and receiving, at the management platform, an answer responding to the electronic approval request. In response to receiving the answer, the method includes automatically forwarding, by the management platform, an electronic license and distribution request to an entity associated with the lead identifier.

### BACKGROUND

Licensors of various technologies, companies, goods, and/or services face many challenges. Such challenges include, for example, increasing product distribution and sales while also growing and developing licensees. Licensors expend significant amounts of time and money in recruiting, developing, and managing potential leads to whom their brands will be licensed. Difficulties in managing leads increase as the quantity of leads increases and/or the quantity of qualifications a lead must satisfy prior to becoming a licensee increases.

In view of these challenges, a need exists for methods, systems, and computer readable media for automated licensing, distribution, and sales.

### SUMMARY

The subject matter described herein relates to methods, systems, and non-transitory computer readable media for automated licensing, distribution, and sales. Such methods and systems advantageously trigger or prompt leads, licensees, and licensors, automatically, to submit various information or data and/or perform various actions necessary to automatically form a license. The methods and systems described herein benefit both licensees and licensors by ensuring consistent license formation, while facilitating swift and automated license termination where the licensee or licensor fail to comply with the terms or conditions set forth therein.

In an exemplary embodiment, a method for automating licensing, distribution, and sales for goods and/or services is provided. The method includes receiving, at a management platform, a lead identifier, determining, at the management platform, whether one or more lead requirements has been satisfied by the lead identifier, sending, by the management platform, an electronic approval request for the lead identifier, and receiving, at the management platform, an answer responding to the electronic approval request. In response to receiving the answer, the method includes automatically forwarding, by the management platform, an electronic license and distribution request to an entity associated with the lead identifier.

In an exemplary embodiment, a method for automated licensing, distribution, and sales comprises receiving, at a management platform, a lead identifier, determining, at the management platform, satisfaction of one or more lead requirements by the lead identifier, triggering, by the management platform, transmission of an electronic approval request for the lead identifier, and receiving, at the management platform, an answer approving or disapproving the electronic approval request. In response to receiving the answer, the method further comprises automatically forwarding an electronic license and distribution request to an entity associated with the lead identifier.

In an exemplary embodiment, a system for automating licensing, distribution, and sales is also provided. The system comprises a management platform comprising a processor, memory, and a communications interface. The processor is configured to execute one or more computing modules stored in the memory for receiving a plurality of lead identifiers, determining completion of one or more lead requirements by the lead identifiers, triggering transmission of electronic approval requests for the lead identifiers, receiving answers approving or disapproving the electronic approval requests, and in response to receiving the answers, automatically forwarding electronic license and distribution requests to entities associated with the lead identifiers.

The subject matter described herein may be implemented in hardware, software, firmware, or any combination thereof. As such, the term “module” as used herein refers to hardware, which may also include software and/or firmware components, for implementing the feature being described.

In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

FIG. 1 is a of a network diagram illustrating methods and systems for automated licensing, distribution, and sales according to some embodiments described herein.

FIG. 2 is a block diagram of a system for automated licensing, distribution, and sales according to some embodiments described herein.

FIG. 3 is a message flow diagram for methods and systems for automated licensing, distribution, and sales according to one embodiment described herein.

### DETAILED DESCRIPTION

The subject matter set forth herein relates to methods, systems, and non-transitory computer readable media for automated licensing, distribution, and sales. The systems and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the instant disclosure.

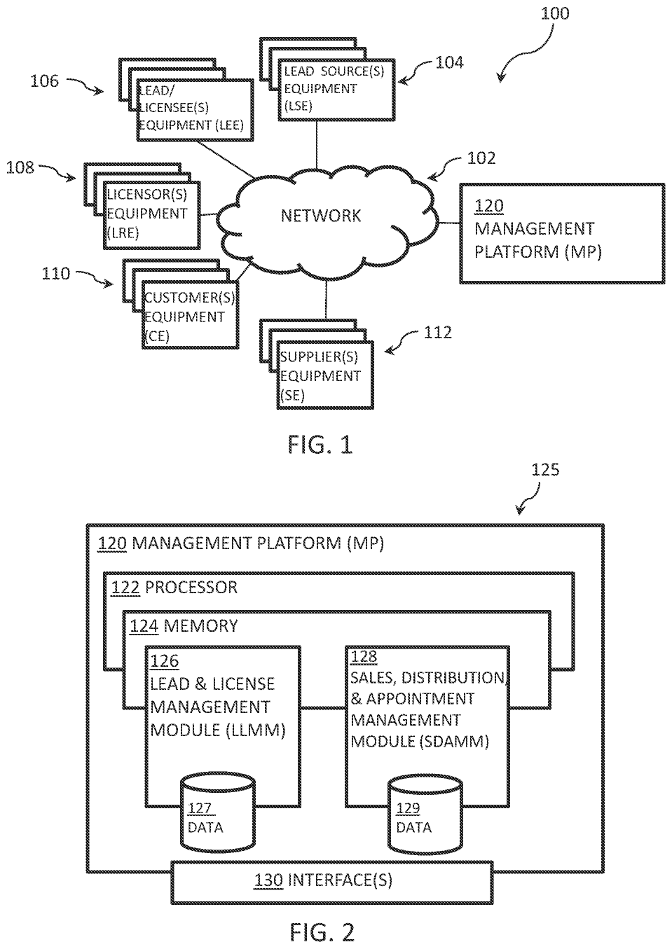

FIG. 1 is a schematic diagram illustrating an exemplary network environment or network architecture 100 associated with the automated licensing, distribution, and sales of goods or services according to an embodiment of the subject matter described herein. The network architecture 100 can facilitate the automatic formation and/or termination of licenses, contracts, or any other type of agreement (e.g., franchise agreements) not inconsistent with the instant disclosure. The licenses (agreements) may be formed and/or terminated in response to various triggers. Such triggers may be conditioned on the accomplishment of (or failure to accomplish) various tasks or objectives identified by the licensee, the licensor, or any other person or entity not inconsistent with the instant disclosure. Automating license formation and termination is advantageously more consistent and simplified. Such benefits are further realized where the quantity of leads for a given licensor is large and/or the quantity of requirements that must be satisfied in order for a lead to be considered eligible for upgrading to a licensee is expansive. Notably, the network architecture 100 obviates the need for the traditional (i.e., manual) methods of verifying completion of lead requirements and/or approving licensees.

As FIG. 1 illustrates, multiple entities are configured to access a communications network 102 and communicate with each other for automating license formation or termination and/or electronically initiating the distribution and sales of goods or services. Such entities include one or more of lead source equipment (LSE) 104, lead/licensee equipment (LEE) 106, licensor equipment (LRE) 108, customer equipment (CE) 110, supplier equipment (SE) 112, and a management platform (MP) 120. As used herein, the term “equipment” refers to mobile or non-mobile communications devices including, but not limited to phones, computers (e.g., laptop computers, tablet computers, desktop computers, etc.), processing devices, smart devices, smart planners or organizers, smart televisions, wearable computers (e.g., a watch, an eyeglass mounted computer, etc.), Internet enabled devices, or any combination thereof. Any other type of network communications equipment not inconsistent with the instant disclosure is also contemplated. The various entities can access and communicate data via network 102 to automatically form and/or terminate licenses and also initiate distribution and sales of goods or services.

The communications network 102 can comprise any type of network not inconsistent with the instant disclosure. For example and in certain embodiments, the network 102 comprises a packet-based communications network (e.g., the Internet) accessed by the various entities (i.e., 104, 106, 108, 110, and 112). Such entities may access the network 102 via a wired or wireless interface (e.g., a WAN, a LAN, a Wi-Fi connection, a radio access connection, etc.) disposed on and/or associated with the respective user equipment. Although not shown for illustration purposes only, each entity (i.e., 104, 106, 108, 110, and 112) associated with the architecture 100 may reside in an individual (e.g., public or privately managed) network, which may include a same network or different networks. Notably, network 102 facilitates the communication of data via packets or packet-based messages, which may be communicated between network entities according to any desired communication protocol as known in the art (e.g., IP, HTTP, TCP, UDP, SIP, etc.). Although a packet-based network is shown for illustrative purposes only, the subject matter described herein is not limited to a packet-based network. Any type of communications network 102 through which messages and/or data can be exchanged electronically between computing entities or platforms may be used without departing from the scope of the subject matter described herein. Such networks may include packet-based networks, circuit-switched networks, or combinations of packet-based and circuit-switched networks.

Referring now to the various network entities associated with architecture 100, each entity can communicate or exchange data with MP 120, which is configured to automate the formation and/or termination of one or more licenses between at least one LEE 106 and LRE 108. Initially, prior to license formation, information regarding a plurality of “leads” is sent to MP 120. As used herein, the terms “lead” and “leads” refer to potential licensees for a licensor's tangible or intangible assets. Leads may be individuals, groups of individuals, or business entities. The LSEs 104 are configured to collect, aggregate, and periodically send lead information to MP 120. Exemplary lead information includes, without limitation, identifying information such as the lead's name, a lead identifier, a business name, a phone number, an email address, a residential address, a business address, or any other type of information by which a licensor may use to identify and/or contact a lead. Exemplary LSEs 104 include clearing houses, recruiters, head hunters, or any other type of lead collecting and aggregating entity not inconsistent with the instant application. LSEs 104 are configured to identify individuals and/or businesses having an interest in licensing tangible or intangible assets from LRE 108 and send identifying information to MP 120. MP 120 is configured to receive the lead information from LREs 104, determine satisfaction of one or more lead requirements, and set and execute various triggers. An exemplary trigger includes automatically sending an electronic license or licensee approval request to LRE 108 upon determining that a lead has satisfied each and every lead requirement. Another exemplary trigger includes automatically forwarding an electronic license and distribution request to each lead that LRE 108 approves as a licensee.

In some cases, prior to license formation, MP 120 is further configured to determine whether a lead has satisfied one or more requirements. Such requirements may be set or specified by LRE 108, LEE 106, or a combination thereof. Once all (or a specified number) of the lead requirements are satisfied, a lead is upgraded to a licensee pending approval by LRE 108. Exemplary lead requirements can comprise, without limitation, payment of one or more fees, securing a contract for the sale, lease, or rental of real property suitable for a business location for approval by LRE 108, confirmation of formation of a corporate or business entity in a specified jurisdiction (i.e., a specified state or country), confirmation of meeting minimum net worth requirements, confirmation of meeting desired work experience, educational background, and/or capital requirements, or any other requirement set forth by a given licensor. MP 120 receives, from LEE 106, electronic confirmation and/or verification of meeting or not meeting the various lead requirements. Once all (or a specified number) of the lead requirements are met and a lead is approved by LRE 108, a license is automatically sent to LEE 106 for execution. Upon receipt of an electronic approval of the license by both LRE 108 and LEE 106, a license, contract, and/or agreement automatically forms. Similarly, the license, contract, or agreement may also be terminated for failure to comply with the terms or conditions set forth therein by LEE 106 or LRE 108.

Upon and/or simultaneous with contract formation, LEE 106 can place one or more orders for goods and/or services via MP 120. For example, upon a request from LEE 106, MP 120 can generate and send an order or distribution request to SE 112. SE 112 is a seller (dealer) or distributor of goods and/or services. MP 120 can automate the sales and distribution of the goods and services, while managing and tracking sales data. MP 120 can collect, account, and optionally report sales data and information to LREs 108. Using the reported information, LREs 108 can optionally terminate a license with any LEE 106 that fails to meet minimum sales or any other requirement set forth in the license. Similarly, LEE 106 can terminate a license with any LRE 108 for failure to comply with the terms of the agreement, where the license or agreement specifies the same. In exemplary embodiments, LREs 108 license their trademark, name, logo, mark, client or customer list, brand, business entity, business model, marketing tools, goodwill, and/or combinations thereof to LEEs 106. In a specific exemplary embodiment, LREs 108 may be a branded furniture or mattress business that licenses at least their name and marketing materials to a plurality of LEEs 106. The SEs 112 may be wholesale furniture or mattress manufacturers or distributors (e.g., SEALY® manufacturers, SERTA® manufacturers, La-Z-Boy® manufacturers, etc.) that sell furniture and/or mattresses to LEEs 106 at a wholesale price. LEEs 106 can then resell the goods consistent the terms of its license with LRE 108. Any other technology, tangibles, intangibles, goods, and/or services may be bought and sold via implementing the automated licenses described herein, not just furniture or mattresses. For example, the license may be for the sale of software, intellectual property, and/or technology in addition to licensing the brand or business. SEs 112 may distribute and LEEs 106 may sell furniture (indoor or outdoor furniture), mattresses, food, clothing, shoes, chemicals, technology, devices, software, vehicles, cosmetics, or any other type of tangibles or intangibles not inconsistent with the instant disclosure.

Still referring to FIG. 1 and in some embodiments, CEs 110 can request and schedule appointments with LEEs 106 to view the goods or services being sold. CEs 110 are consumers, clients, or customers of LEEs 106. CEs 110 can send a calendar request to MP 120 requesting a meeting with a specified LEE 106. MP 120 can then send the request to the specified LEE 106 calendar the request on the specified LEEs 106 master calendar. In some instances, MP 120 is also configured to send reminders to CE 110 and/or LEE 106 regarding scheduled appointments via messaging (e.g., a Short Message Service (SMS) message, a Multimedia Messaging Service (MMS) message, an email, an automated phone call and/or message, etc.). Notably, MP 120 is a centralized server or computing platform by which leads, licenses, sales, distributions, and/or appointments are managed and automated. Multiple different and/or discrete entities can interact and employ MP 120 to electronically manage various aspects of a business, including aspects associated with a business's operations and sales, such as managing leads, automating licensing, calendaring of appointments, and/or automating distributions.

Notably, MP 120 is a special purpose computing device or machine that includes hardware components (e.g., one or more processor units, memory, and network interfaces) configured to execute hardware and software elements (e.g., APIs, computing modules, etc.) for the purposes of performing one or more aspects of the subject matter set forth herein. In addition, it should be noted that MP 120 and its components and/or functionality described herein constitute a special purpose computer that improves the technological field of electronic lead recruiting, lead management, and automated license formation and/or termination by obviating the need to manually manage leads, determine satisfaction of lead requirements, and/or approve licensees. MP 120 further provides mechanisms for electronically executing licenses and/or terminating licenses, automatically after a predetermined period of time, when any party to the license fails to comply with the terms of the license.

It will be appreciated that FIG. 1 is for illustrative purposes only and that various entities, their locations, and/or their functions described above in relation to FIG. 1 may be changed, altered, added, or removed. For example, some components and/or functions may be separated or combined into one entity, e.g., MP 120 or some functionality thereof may be integrated with any of the other entities associated with architecture 100. Alternatively, the functionality of MP 120 may be separated and/or distributed across multiple computing nodes or machines.

FIG. 2 is a block diagram of a system, generally designated 125, for automated licensing, distribution, and sales according to some embodiments described herein. In some embodiments, the system comprises MP 120, which has at least one processor 122, at least one memory 124 (e.g., a memory component, element or device), and at least one communication interface 130. MP 120 is configured to utilize processor 122, memory 124, and interface 130 to execute software to send, receive, and/or exchange data (information) by or between LSEs 104, LEEs 106, LREs 108, CEs 110 and/or SEs 112. In some embodiments, packets or message traffic (e.g., requests, responses, etc.) is sent, received and/or otherwise communicated or exchanged between MP 120 and the other network entities via one or more communication interfaces 130 according to the methods described herein for providing an electronic alternative to manually managing/approving leads and forming licenses.

In some instances, the processor 122 is a microprocessor, such as a central processing unit (CPU), or any other hardware-based processor unit that is configured to execute and/or utilize software to communicate with the multiple entities (e.g., or servers associated therewith) for processing and managing leads, processing and managing sales/distributions, and forming licenses. Processor implements the subject matter described herein by processing computer readable media stored in the memory 124.

The memory 124 is configured to store software executed via processor 122, and can comprise, without limitation one or more disk memory devices, chip memory devices, programmable logic devices, random access memory (RAM), read only memory (ROM), optical read/write memory, cache memory, magnetic read/write memory, flash memory, and/or application specific integrated circuits. The processor 122 and memory 124 may be disposed on a single device or computing platform or distributed across multiple devices or computing platforms.

MP 120 further comprises a lead and license management module (LLMM) 126 and a sales, distribution and appointment management module (SDAMM) 128. Each module is executed by the processor 122 and stored in memory 124. LLMM 126 and SDAMM 128 can comprise hardware, software and/or firmware components for implementing automated licensing formation or termination and distribution of goods or services as described herein. In one exemplary implementation, LLMM 126 includes functionality for collecting lead information, managing lead information via verifying completion of lead requirements, executing licenses between licensors and licensees, automatically, in response to approval of a licensee by licensor, and/or terminating licenses when the terms of the license are not being satisfied by either party. SDAMM 128 includes functionality for managing sales, generating and reporting sales data, automating distribution requests, and scheduling appointments for customers and licensees. LLMM 126 can execute licenses and/or manage leads using data 127. The data 127 may be input, output, generated and/or stored and accessed by LLMM 126. Such data 127 may include, without limitation, lead identifying information, lead requirement data, license information, license terms, etc.

Likewise, SDAMM 128 can manage sales, generate sales reports and data, and schedule appointments using data 139. The data 129 may be input, output, generated and/or stored and accessed by SDAMM 128. Such data 129 may include, without limitation, sales data, revenue data, tax data, appointment data, customer data, calendar data, customer identifiers, marketing data, etc. The data (i.e., 127 and 129) may be populated and stored in any type of storage element, component, or device, not limited to a database, a data table, a cache, a storage drive, or any other collection of records or information including pending transactional data for processing upon delivery of an ordered good or service.

Although only one communications interface 130 is illustrated, one or more additional communications interfaces 130 may also be provided whereby connections to the network 102 (FIG. 1) or other remote entities are established. That is, communications interface 130 may include an interface by which packet data messages are received, sent, and/or exchanged. MP 120 is a hardware computing device and/or a computing platform including a communications interface 130 by which the computing modules 126 and 129 send, receive, and/or exchange electronic data for developing leads, managing leads, forming licenses, terminating licenses, scheduling appointments, and/or requesting distribution of goods or services. MP 120 is configured to receive an indication that a lead is interested in entering a license with a licensor, indications that lead requirements are completed or not, and/or authorizing sales and distributions.

It will be appreciated that FIG. 2 is for illustrative purposes only and that various components and/or functions thereof as described above in relation to FIG. 2 may be changed, altered, added, or removed. For example, some components and/or functions may be separated or combined into one entity. Alternatively, the functionality of MP 120 may be distributed across multiple computing nodes, platforms, or machines.

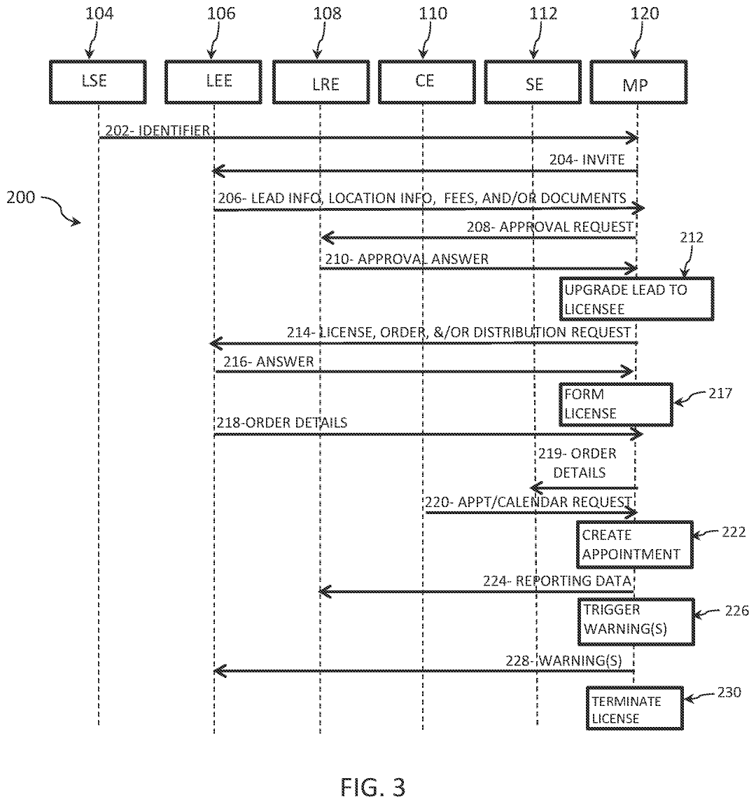

FIG. 3 is a message flow diagram illustrating exemplary messaging associated with a method, generally designated 200, for the automated licensing, distribution, and sales according an embodiment described herein. At 202, lead information is sent from LSE 104 to MP 120. The lead information can comprise a lead identifier received at MP 120. Exemplary lead identifiers include lead names, lead phone numbers, lead email addresses, usernames, a series of unique numbers and/or letters identifying leads, or any other type of identifying information associated with one or more leads.

At 204, MP 120 sends an invite to LEE 106. The invite can comprise instructions or a link by which LEE 106 can enroll or subscribe to MP 120. Upon enrolling or subscribing to MP 120, LEE 106 can transmit, send, or otherwise upload data or information each time a lead requirement is satisfied. For example, at 206, LEE 106 sends and MP 120 receives lead information, location information, fees, and/or other data, information, or documents necessary to indicate fulfillment of one or more lead requirements. Location information may include an address, lease, photographs, map information, a rental agreement, or a contract for the purchase, sale, lease, rental or other acquisition of real property (e.g., for use as a showroom, an office, etc.) as required by LRE 108. LRE 108 may require submission of such data, information, photographs, or documents prior to approving LEE 106 as a licensee and/or prior to forming a license with LEE 106. MP 120 is configured to manage, collect, store, aggregate, track, and/or verify the satisfaction, completion, and/or fulfillment of various lead requirements by LEE 106.

At 208, MP 120 determines that all of the lead requirements (or a sufficient number thereof) are fulfilled and automatically sends an approval request to LRE 108. At 210, LRE 108 sends an approval answer, by which LRE 108 either approves or disapproves upgrading a lead to a licensee. At 212, the lead is approved as a licensee and upgraded.

At 214, MP 120 automatically sends a license and request to LEE 106, the approved licensee. Simultaneously with sending the license, MP 120 may also send an order and distribution request by which LEE 106 places an initial order for goods or services. At 216, LEE 106 agrees to enter a license agreement with LRE 108 and a license is formed at 217. The license may include various terms or conditions which, if not satisfied, may result in the automatic termination of the license by MP 120.

At 218, LEE 106 places an order by sending order details to MP 120. Such order details may include, without limitation, the type of good being ordered, the quantity of goods being ordered, the brand name of goods being ordered, part numbers for goods being ordered, delivery instructions or details for the one or more goods or services being ordered, or any other information not inconsistent with the instant disclosure. MP 120 can track and store such order details. At 219, MP 120 sends the order details to SE 112, the supplier or manufacturer of the goods or services. Upon receiving the order, SE 112 will send and/or deliver the purchased goods and/or services to LEE 106.

At 220, CE 110 requests an appointment and sends a calendar request to MP 120. At 222, MP 120 creates the appointment and notifies LEE 106 and CE 110 of the appointment details. MP 120 is configured to send one or more reminders to LEE 106 and/or CE 110 in advance of the appointment, in some cases. Further, if CE 110 fails to make a purchase during the scheduled appointment, MP 120 can send one or more reminders or incentives to CE 110 for inviting CE 110 to make a purchase.

At 224, MP 120 transmits or sends reporting records or data to LRE 108. Such data may include sales and ordering data, total sales, monthly/weekly sales, gross/net sales data, gross/net profit data, debt data, budget data, overhead data, distribution data, appointment data, or any data or other information as requested by LRE 108 and/or as set forth in the license.

At 226, MP 120 determines, via tracking, for example, sales and/or order data, that LEE 106 is not complying with the terms of the license, and triggers one or more warnings 226. Warnings may be triggered, for example, where LEE 106 fails to make any sales over a given period of time or fails to place any orders or send distribution requests for goods/services over a specified period of time. LRE 108 and/or LEE 106 may set or specify various warnings to track and monitor the other party's compliance with the terms of the license. At 228, MP 120 sends the warnings to LEE 106. At 230, MP 120 terminates the license between LEE 106 and LRE 108. Although not shown, the warnings may also be sent to LRE 108 and the license may be terminated in instances where LRE 108 fails to comply with the duties or tasks identified in the license. The warnings transmitted at 228 may specify a time period by which LEE 106 (or LRE 108) can meet the terms of the license. Upon expiration of the specified time period, the lease can be automatically terminated by MP 120.

It will be appreciated that FIG. 3 is for illustrative purposes only and that various messaging and/or aspects thereof as described above in relation to FIG. 3 may be changed, altered, added, or removed. The messaging depicted in FIG. 3 may include additional/subsequent messaging as described herein, and some messaging may be combined or separated. Notably, MP 120 is configured to manage and track multiple (e.g., hundreds, thousands, etc.) leads per month/year/etc., and monitor the status of multiple licenses for improved license consistency and formation.

A non-limiting example regarding the instant subject matter is provided below. Numerous modifications and adaptations will be apparent to those of skill in the art without departing from the instant disclosure.

### EXAMPLE 1

### Licensing an Outdoor Furniture Business

In one non-limiting example, an automatic license for an outdoor furniture business is formed via the methods, systems, and computer readable media set forth herein. Data regarding a potential licensee (i.e., a “lead”) of the business is sent to the management platform. The data may be sent to the management platform by a lead source, such as a clearing house, a recruiter, a dealer, a franchise site, the potential licensor, etc. The management platform will then contact the lead using the information provided by the lead source and prompt the lead to subscribe or set up an account with the platform.

Once the lead subscribes to and/or establishes an account with the management platform, the platform will then prompt the lead to submit various documents, fees, data, information, etc., to the platform to satisfy various lead requirements that are set or established by the business licensor. For example, the business licensor may require a fee, a city and state for a proposed business location, a picture of the proposed business location (e.g., a picture of a storefront, building, etc.), and the geographical location (address) of the proposed business location. The licensor may further require verification that the lead has registered with the secretary of state for approval to form a business in the state, established tax/IRS accounting numbers or identifiers for the business, established a business banking account, has acquired insurance, or the like.

Upon satisfactorily completing all (or a specified amount) of the lead requirements, the management profile will then prompt the business licensor to approve or disapprove of the lead and extend a license agreement. Once the license is approved and accepted by the licensee, a license will automatically form between the business licensor and the lead, which is now upgraded to an outdoor furniture business licensee. The license may allow the licensee to access various data, accounting information, software, websites, customer lists, marketing materials, copyrights, trademarks, or any other tangible or intangible asset as specified in the license. Upon formation of the license, the licensee will also be automatically prompted to place an initial order for pieces of outdoor furniture to sell and/or showcase in their place of business. The order will be communicated to one or more furniture manufacturers (i.e., Harmonia Living®, Gloster®, etc.), who will then ship the outdoor furniture to the licensee for the licensee to sell.

Customers may then access the management platform (e.g., via a phone, computer, etc.) to schedule appointments to view the outdoor furniture for sale in the licensee's showroom. The management platform can generate and send calendar requests to both customers and licensees to set appointments. The management platform can also communicate reminders to the customers and licensee prior to the scheduled appointment.

During the appointment, the customer may purchase outdoor furniture. The licensee can replenish sold inventory by ordering more furniture using the management platform. Where the customer does not make a purchase, the management platform may follow up (e.g., via a text message, an email message, etc.) with the customer after a predetermined amount of time to send offers, deals, or incentives prompting the customer to make a purchase. For example, where a customer does not purchase an outdoor dining set during a scheduled appointment, the management platform can send the customer a text message within 24 hours offering an incentive, such as perhaps a free outdoor umbrella, upon purchase, a percentage off of the purchase, etc. The management platform can communicate sales, business, and/or customer data to the business licensor, where desired.

The management platform can also terminate the license, should the licensee or the licensor fail to comply with the terms of the license. For example, if a licensee does not place a single order for outdoor furniture within a given amount of time (e.g., 2 weeks, 4 weeks, 6 weeks, etc.) then the license may be terminated. Further, if the licensee does not place an order for a certain quantity of outdoor furniture (e.g., 5 chairs, 10 chairs, etc.) or dollar amount of inventory ($500 worth of inventory, $1000 worth of inventory, etc.), then the licensed may be terminated. The licensee may receive one or more warnings prior to license termination. The terms and conditions for terminating a license will be agreed to by both parties upon license formation, and may vary per license, where desired.

It will be understood that various details of the subject matter described herein may be changed without departing from the scope of the subject matter described herein. Furthermore, the foregoing description is for the purpose of illustration only, and not for the purpose of limitation.

What is claimed is:

1. A method of automating licensing, distribution, and sales, the method comprising:
receiving, at a management platform, a lead identifier;
determining, at the management platform, whether one or more lead requirements has been satisfied by the lead identifier;
sending, by the management platform, an electronic approval request for the lead identifier;
receiving, at the management platform, an answer responding to the electronic approval request; and
in response to receiving the answer, automatically forwarding, by the management platform, an electronic license and distribution request to an entity associated with the lead identifier.

2. The method of claim 1, further comprising receiving, at the management platform, an indication that an initial lead requirement has been fulfilled by the entity associated with the lead identifier.

3. The method of claim 1, further comprising receiving and processing, at the management platform, an initial request for distribution of goods or services.

4. The method of claim 1, further comprising receiving, at the management platform, a calendar request, and scheduling, by the management platform, an appointment for the entity associated with the lead identifier.

5. The method of claim 1, further comprising periodically reporting, by the management platform, sales and distribution data associated with the lead identifier to a licensor.

6. The method of claim 5, further comprising:
determining, by the management platform, whether the sales and distribution data has been reported; and
sending, by the management platform, a warning in response to a lack of sales and distribution data associated with the lead identifier.

7. The method of claim 6, further comprising transmitting, by the management platform, a warning message to the entity associated with the lead identifier.

8. The method of claim 7, further comprising terminating, by the management platform, the license, electronically, with the entity associated with the lead identifier.

9. A system for automating licensing, distribution, and sales, the system comprising:
a management platform comprising a communications interface, a processor, and a memory storing instructions that, when executed by the processor, cause the processor to perform the steps of:
executing one or more computing modules stored in the memory for receiving a plurality of lead identifiers;
determining whether one or more lead requirements has been completed by the lead identifiers;
triggering transmission of electronic approval requests for the lead identifiers;
receiving answers to the electronic approval requests; and
in response to receiving the answers, automatically forwarding electronic license and distribution requests to entities associated with the lead identifiers.

10. The system of claim 9, wherein the lead identifiers include names or telephone numbers associated with a plurality of leads.

11. The system of claim 9, wherein a first lead requirement includes confirmation of securing a contract for a sale, lease, or rental of real property.

12. The system of claim 9, further comprising a database, a data table, a cache, or a storage drive.

13. The system of claim 12, wherein the instructions, when executed by the processor, further cause the processor to populate the database, the data table, the cache, or the storage drive with sales, order, and/or distribution data.

14. The system of claim 12, wherein the instructions, when executed by the processor, further cause the processor to populate the database, the data table, the cache, or the storage drive with customer data.

15. The system of claim 9, wherein the instructions, when executed by the processor, further cause the processor to schedule appointments for licensees.

16. The system of claim 15, wherein the instructions, when executed by the processor, further cause the processor to send reminders regarding the scheduled appointments.

17. The system of claim 9, wherein the instructions, when executed by the processor, further cause the processor to automatically terminate a lease where a licensee or licensor fail to meet the terms or conditions set forth in the lease.

18. A non-transitory computer readable medium including a processor and a memory having stored thereon executable instructions that, when executed by the processor, cause the processor to perform the steps of:
receiving a lead identifier;
determining satisfaction of one or more lead requirements by the lead identifier;
triggering transmission of an electronic approval request for the lead identifier; and
receiving an answer to the electronic approval request; and
automatically forwarding an electronic license and distribution request to an entity associated with the lead identifier in response to receiving the answer.
